(19) United States
(12) Patent Application Publication
(10) Pub. No.: US 2023/0196640 A1
(43) Pub. Date: Jun. 22, 2023

(54) METHOD AND SYSTEM FOR MOVEMENT COMPENSATION DURING CT RECONSTRUCTION

(71) Applicant: Siemens Healthcare GmbH, Erlangen (DE)

(72) Inventors: Johan SUNNEGAARDH, Adelsdorf (DE); Nora Steinich, Forchheim (DE); Harald Schoendube, Erlangen (DE)

(73) Assignee: Siemens Healthcare GmbH, Erlangen (DE)

(21) Appl. No.: 18/065,897

(22) Filed: Dec. 14, 2022

(30) Foreign Application Priority Data
Dec. 17, 2021 (EP) 21215485.0

(51) Int. Cl. G06T 11/00; G06T 7/20

(52) U.S. Cl. CPC G06T 11/008; G06T 11/005; G06T 11/006; G06T 7/20; G06T 2211/424; G06T 2211/421

(57) ABSTRACT

A method for movement compensation during CT reconstruction, comprises calculating slice images. The calculating slice images comprising: selecting an initial movement state; calculating a reference voxel position in relation to the initial movement state; calculating a column image position of a voxel; ascertaining a changed movement state of the voxel at the column image position; calculating a changed voxel position in relation to the changed movement state; calculating a changed image position of the voxel; and using an image value of the intermediate image at the changed image position for back projection to calculate the slice images.

### CROSS-REFERENCE TO RELATED APPLICATION(S)

The present application claims priority under 35 U.S.C. § 119 to European Patent Application No. 21215485.0, filed Dec. 17, 2021, the entire contents of which are incorporated herein by reference.

### FIELD

One or more example embodiments of the present invention relate to a method and to a system for movement compensation during CT reconstruction, therefore the reconstruction of slice images during computed tomography (CT), in particular by taking into account a re-binning process.

### BACKGROUND

Movements during image acquisition in a CT scan cause artifacts, which seriously impair the image quality and can reduce the diagnostic value of the resulting images. The movement results in an inconsistency of the captured data and therewith in artifacts such as blurring, streaking or ghost images.

This movement is frequently a patient movement. Patient movements can be involuntary movements such as organ movements or tremors, but also voluntary movements, for example in the case of uncooperative patients, in emergencies or in pediatric imaging. The artifacts can also be brought about by movements of the scanner itself, however, by way of example in the case of mobile CT systems, for example with a moving or displaceable gantry.

The ideal solution to the problem would be complete prevention of any form of movement during the scan, which unfortunately, as a rule, is not a realistic option. A solution is therefore necessary, which can compensate artifacts caused by a movement and improve the image quality.

A method for movement compensation that is frequently used during CT reconstruction is that by Schafer et al. (“Motion-compensated and gated cone beam filtered back-projection for 3-D rotational X-ray angiography,” in IEEE Transactions on Medical Imaging, vol. 25, no. 7, pp. 898-906; July 2006). The method proposed there is based on the assumption that the movement present during the CT scan is known. The movement correction is applied in the reconstruction process during the back projection step. Each voxel (three-dimensional image point) of the volume to be reconstructed is virtually displaced in accordance with the movement present at the moment of the acquisition. This method includes the reconstruction algorithm by Feldkamp, David and Kress (“Practical cone-beam algorithm,” J. Opt. Soc. Am. A 1, 612-619; 1984). The Schafer et al. method is frequently used as a movement compensation method after new movement estimation methods for CT scans were proposed, such as by Bruder et al. (“Compensation of skull motion and breathing motion in CT using data-based and image-based metrics, respectively”, Proc. SPIE 9783, Medical Imaging 2016: Physics of Medical Imaging, 97831E; 22 Mar. 2016).

A further method for movement compensation during CT reconstruction is based on the partial angle reconstruction (see J. Hahn et al. “Motion compensation in the region of the coronary arteries based on partial angle reconstructions from short-scan CT data. Medical physics, 44(11); 2017). In this method the movement compensation is carried out separately on a plurality of partial angle reconstructions, which are incomplete reconstructions from a subset of the data. The complete movement-compensated reconstruction is obtained by combining the movement-compensated partial angle reconstructions. The movement compensation itself takes place in a manner very similar to the method by Schafer et al. in that the voxel volume is moved in accordance with the movement at hand.

The drawback of the reconstruction methods, however, consists in that in combination with reconstruction algorithms, which include a re-binning step, artifacts remain, which reduce the quality of the result of movement compensation.

### SUMMARY

It is an object of one or more example embodiments of the present invention to disclose a method and a corresponding system for movement compensation during CT reconstruction with which the above-described drawbacks are avoided and, in particular, an optimum movement compensation after a re-binning is also made possible.

This object is achieved by a method, a system, a control facility or device and a computed tomography system, according to one or more example embodiments of the present invention.

In an embodiment, the inventive method for movement compensation during CT reconstruction comprises the following steps:
providing projection images of a CT scan,
creating intermediate images, wherein the intermediate images are created from a re-binning of columns of the projection images,
calculating slice images via a back projection of the intermediate images onto predetermined voxels of the slice images, wherein for each intermediate image and for each voxel, on the basis of a predefined movement profile (with movement data) of the voxels during the acquisition of the projection images, the following steps are carried out:
   a) selecting an initial movement state on the basis of the intermediate image,
   b) calculating a reference voxel position of the voxel from its original voxel position and from the movement profile (therefore with the movement data of the movement profile) in relation to the initial movement state,
   c) calculating a column image position at which the voxel would be mapped in the intermediate image at the reference voxel position,
   d) ascertaining a changed movement state of the voxel on the basis of the calculated column image position,
   e) calculating a changed voxel position of the voxel from its original voxel position and the movement profile in relation to the changed movement state,
   f) calculating a changed image position at which the voxel would be mapped in the intermediate image at the changed voxel position,
   g) using an image value of the intermediate image at the changed image position for the back projection.

Projection images of a CT scan can be provided by acquiring the images with a CT scanner, by simulating CT images or by accessing a database in which previously acquired (or simulated) projection images have been stored. Let it be understood that the term “projection images” is not intended to mean images which have already been reconstructed, but images which have been produced on a detector by projection of an X-ray beam through an examined object. This is preferably raw data of a CT scan, but can definitely also be pre-processed data in which, for example, noise has been suppressed.

The projection images are frequently acquired with a cone-shaped beam during a movement of X-ray source and detector on a circular or helical trajectory. This is basically irrelevant to the present invention, however.

Intermediate images are created from the projection images via re-binning. The intermediate images are likewise projection images, although the term “intermediate images” will also be used for differentiating them better in order to indicate that these images are used for reconstruction merely as an intermediate stage. It should be noted that this can also take place before downloading the projection images from a database. An acquisition can therefore definitely occur, re-binning of the projection images can take place and the intermediate images produced thereby can be temporarily stored in a database.

During re-binning of the projection images the columns of the projection images are allocated to different intermediate images. Hereinafter the coordinates of the columns will be indicated by “p” and the coordinates of the rows by “q”. With a cone-shaped X-ray beam a projection image is acquired with a beam cone. The individual pixels (which basically correspond to bins) on a detector thus receive intensity information from beams of the X-ray source, with different detector pixels detecting beams from different angles owing to the conical shape of the X-ray beam. Some frequently used reconstruction methods require a parallel beam geometry, however. Other projection methods can require different beam geometries.

In order to convert intermediate images “acquired” in parallel, those beams, which were parallel to beams of other projection images respectively during the acquisition, are selected from a large number of projection images (which were acquired in different positions of the measuring apparatus). Since detector and X-ray source co-rotate during the acquisition, but the acquisition positions (in the space) are known for each beam, its angle in the space can be calculated from its acquisition position and the respective image position. In parallel projection the bins would not be the individual pixels, but the individual columns of the projection images. By way of example, in a simple example the first intermediate image could be formed from the values of the rows p=1 of the first projection image, p=2 of the second projection image, etc. For the second intermediate image, this would then be, for example, p=2 of the first projection image, p=3 of the second projection image and so on. In this way parallel projection images are obtained in which the column image position (p-coordinate) simultaneously corresponds to a course over time since the rows originate from different acquisitions at different acquisition instants and therewith also correspond to a particular movement state.

The intermediate images can optionally be filtered after re-binning. By way of example, a convolution can take place. During a preferred convolution step the projection images are filtered for a better reconstruction result. Instead of (or in addition to) a convolution, a multiplication can also be carried out in the Fourier space, however. The intermediate images are subjected to a Fourier transform and multiplied by an adjusted filter in the Fourier space. This can be more efficient than a convolution of the intermediate images. Filtering of this kind is basically prior art.

The slice images are now calculated via a back projection of the intermediate images. This is known per se in the prior art (see for example the above-mentioned paper by Schafer et al. or the paper mentioned below by Stierstorfer et al.). In addition, particular steps for movement compensation are carried out during the course of this calculation, however, which take into account the re-binning. During the calculation, voxels (three-dimensional image point or volume pixel) are considered, which correspond to the region at which the object was examined or an image point of the slice images to be reconstructed. Values of the voxels thereby ultimately reproduce the image points of the reconstructed slice images, with each pixel of a slice image corresponding to a voxel of a slice of the acquired volume.

The back projection (known per se) uses the intermediate images for calculating the actual slice images. The aim of the back projection step is the reconstruction of the voxel volume, which represents the patient or the scanned object, and which is formed from said voxels. This is carried out in that each voxel for each intermediate image (after the re-binning and optionally the filtering) is considered separately. For each voxel, a beam is calculated, which goes through the voxel and the corresponding position in the intermediate image. The information of the corresponding position in the intermediate image is then used for the back projection. As soon as this has occurred for all voxels in the volume, the process is repeated for the next intermediate image until all intermediate images have been taken into account. One or more example embodiments of the present invention specify which value exactly from the intermediate image is now used for the back projection.

Each voxel has a voxel position, which can be a three-dimensional coordinate or a three-dimensional vector. Hereinafter a coordinate will be mentioned, with this incorporating a vector being incorporated thereby. As was stated previously, the voxels represent volume elements of the acquired object and are thus located in a virtual space, which corresponds to the field of view. The voxel position therefore is a position in this virtual space.

A known movement profile is assumed for a movement compensation during the course of calculation. This relates to the field of view (that region at which the object was situated during the acquisition) and therewith the movement of the voxels. Since the voxels are defined by their respective voxel positions, the movement profile relates to the change in the respective voxel positions of the voxels. For this, the movement profile comprises movement data relating to the individual voxels, or the movement profile is a collection of movement data for the individual voxels.

How a movement profile is created is prior art. For example, a patient can be filmed by a camera during an acquisition and the movement profile derived from the camera acquisitions. Movement estimation methods also exist for CT scans, however, as is stated in more detail for example in the work by Bruder et al. (“Compensation of skull motion and breathing motion in CT using data-based and image-based metrics, respectively”) mentioned in the introduction. The movement can be measured with sensors, for example with movement sensors, which are attached to scanners in order to measure the movement of the scanner, or 3D cameras in order to measure the movement of the patient.

Put simply, the movement profile is characterized such that (with its movement data) it reproduces the movement of each individual voxel over the acquisition time or may at least be interpolated. Since, as a rule, this requires a very high storage requirement in practice (with 512 voxels per image axis, 30 acquisitions and two bytes per voxel coordinate the movement profile would be approx. 25 GB in size), the movement profile can also be based on approximations, undersamplings and/or interpolations and/or include predefined regions without movement. By way of example, it is sufficient if in respect of a heart the movement of some points of the walls is known and the movement of the voxels in the volume of the heart is calculated on the basis of these points, with here too only those voxels, which lie in the movement region of the walls, having to be taken into account. As will be explained in more detail below, the movement profile can originate from approximate values or models for the movements. For example, a rigid movement can be assumed, for which only movement data for the translation, rotation and displacement of the center of rotation for the entire scanned object is necessary merely for a large number of instants (optionally each relevant instant). In this case, the entire volume therefore moves in an identical manner and only one set of movement parameters is required for the entire volume instead of for each individual voxel. This approach thus requires very little storage space.

The further reconstruction steps are now carried out with the movement profile for each intermediate image and for each voxel (with a known initial voxel position x). The aim is to allocate the correct image information respectively to the voxels (the voxels on the path of a beam are meant here, and this is required for back projection). While, as stated, the reconstruction of slice images from the intermediate images is known, due to their movement the mappings of the voxels are often not located where they should be (without movement) in the intermediate images. Consequently, without a movement compensation, image contents are sometimes allocated in the prior art to the voxels, which do not actually correspond to the mapping of these voxels. This results in artifacts in the slice images and is undesirable. With the subsequent, particular steps for movement compensation, it is basically ascertained where in the intermediate images the image information of a voxel may be found, and precisely this image information is used for the voxel.

For a better understanding of the following statements it should be noted that a movement of a voxel is basically just a change in its voxel position during the acquisition time. During this acquisition time a plurality of projection images is acquired at different acquisition instants, so each projection image shows the voxel at its current voxel positions respectively. In its columns each intermediate image also simultaneously shows a course over time since the rows originate from different projection images. The column image position (p-coordinate) thus basically corresponds to a time coordinate and each p-coordinate also thereby corresponds to another movement state of the voxels.

Since the exact acquisition instant is known for each P-coordinate of an intermediate image (it is indeed known from which projection image the image information at this P-coordinate originates and when this projection image was acquired), the movement state at this location is also known. The current voxel position respectively can be calculated with the movement state (or the acquisition instant) from the movement profile. Basically, the variables “movement state” and “acquisition instant” are synonymous for the voxel positions since a particular movement state prevailed at a particular acquisition instant. For a clearer understanding it is assumed in the following that, with a known movement state, the voxel positions can be directly determined from the movement profile, with it being possible for the same to of course also apply to a known acquisition instant. It should be noted in this regard that the column image coordinate p of different intermediate images does not necessarily have to be identical to the movement state since, for example, the center of the intermediate images corresponds to identical p-coordinates, but, as a rule, to different movement states. Since however, as stated, it is known from which projection images the image contents of the intermediate images originate, the respective movement state can be derived from each p-coordinate of each intermediate image and can thus be used as a “global parameter” for the p-coordinates.

In short: the movement profile comprises movement data for different movement states. For a known movement state, the desired movement data can be selected from the movement profile and be used for calculating a voxel position according to the steps b) or e). The movement data can also be in the form of functions of the movement state. For the simple case of a simple translation z(t) with the translation function z and the movement state t, a changed voxel position x′ for a known movement state T could be calculated simply from x′=z(T).

For movement compensation, firstly an initial movement state is selected on the basis of the intermediate image, with preferably different initial movement states being selected for different intermediate images. This initial movement state can basically be arbitrarily selected, but is preferably located in the center of one intermediate image being considered respectively. When the centers of the intermediate images are considered respectively, simple and standardized calculations are possible. While each intermediate image is thereby considered in relation to a different movement state (the acquisition instant of the central column image position is, as a rule, different for each intermediate image), this does not have any adverse effects on the result since, in the end, everything is attributed to the (unmoved) original voxel volumes.

In relation to the term “center” it should be noted, however, that there can be a plurality of reference systems, which can define a “center” in the intermediate image. Firstly this would be the center of the image. This would lie in half of the columns. The situation is such, however, that it is not imperative that the detector is always symmetrical. If the center is defined via the center of rotation of the gantry, it is possible that during an acquisition the detector stays to the left of this center for longer than to the right of this center. This is then reflected accordingly in the p-coordinates of the intermediate images. In this case, the center is not imperatively located in the center of the intermediate image, but can be displaced slightly to the left or right.

The respective centers (half of the columns) of the projection images can also be particularly preferably assumed, however. These can be regarded as the centers of the intermediate images, therefore the column in the intermediate image, in which a center of a projection image is therefore present. At this particular position the angle of rotation of the gantry in cone beam geometry is identical to the virtual angle of rotation of parallel beam geometry and thus at this position the movement states from projection image and the corresponding intermediate image are identical. As previously stated, this center of the projection image does not necessarily have to also lie in the center of the intermediate image. For the sake of simplicity and for a clearer understanding of the present invention, the center can be envisaged in the center of the projection image for the following embodiments, however.

When calculating a reference voxel position (voxel position relating to the initial movement state) from the movement profile, this is now calculated in relation to the selected initial movement state. As was stated above, the movement profile is configured accordingly.

For example, in a simple but memory-intensive embodiment it is possible to easily ascertain in a lookup table relating to the relevant movement state (acquisition instant) how exact the position of the voxel must have been. The voxel position can, however, also be calculated from a function via the movement states by calculating the function for the relevant movement state.

For example, the movement profile can specify that a translation z and a rotation R (R is, for example, a matrix) takes place around a pivot point c. The movement state (indicated here by “t” to represent the proximity to an acquisition instant) can therefore be in the form of a dataset of functions z(t), c(t) and RT. A voxel position xM relating to initial movement state T may then be calculated from the original voxel position x from the formula xM=RT(x−c(T))+c(T)+z(T). Let it be understood that it is assumed here that the voxel to be reconstructed moves like a patient or scanned object moved during the acquisition (optionally also due to errors in the sequence of movement of the scanner).

For a voxel at a voxel position x, its reference voxel position xM is therefore calculated for the initial movement state. The following step calculates where the voxel (which is located at the reference voxel position) would be seen in the intermediate image.

In this regard at least the column image position p, or the two-dimensional image position (p, q), is calculated at which the voxel would be mapped in the intermediate image at the reference voxel position xM. The position in the q-direction is not a problem and also has only minor relevance to the fundamental method. Since the beam path is known (this was the basis for re-binning) it is possible to easily determine where a beam with a known direction through this voxel would have impinged on the intermediate image. With parallel beam geometry, for example simply the projection of the voxel on the intermediate image has to be considered.

It should be noted in this regard, however, that each column image position p in an intermediate image corresponds to a particular acquisition instant and therewith a particular, “changed movement state”, which no longer has to correspond to the initial movement state (and, as a rule, it does not, either). The voxel could have been located at another voxel position in relation to this changed movement state (at the ascertained column image position p) owing to its movement.

In short: if a voxel is not directly mapped in the center of an intermediate image, a different movement state to the initial movement state simultaneously prevailed and the voxel could have been located somewhere else at this “instant”.

The changed movement state of the voxel is therefore now ascertained on the basis of the calculated column image position p. The changed movement state could be calculated directly from the column image position.

The changed column image position p′ is now calculated in accordance with the above-described calculation of the column image position p. In addition, the changed row image position q′ is still calculated here, however, so the two-dimensional coordinate (p′, q′) exists. The changed row image position q′ can be simply calculated again in that a calculation is made as to where a (known) beam through the voxel at the changed voxel position x′ would impinge with its predefined angle on the intermediate image. It should be noted in this regard, however, that if a conical beam geometry was present during the acquisition, the conical shape in the q-direction is retained even with parallel re-binning.

Finally the image value at the changed image position (p′, q′) is taken in the intermediate image and used as a value for the back projection (and optionally also allocated to the voxel or a group of voxels).

This occurs for all voxels for an intermediate image, and then once again for each voxel for another intermediate image until all relevant intermediate images have been processed.

In principle, the process can be summarized in that it does not proceed with the first voxel position that comes along and instead an iteration step is carried out first of all. While it may appear that this method does not proceed very accurately because the voxel at the “instant” of the changed column image position p′ could have been located somewhere else again, it has been found that the image quality can be significantly improved even with a single iteration step. Of course further iteration steps are possible, however, as will be addressed below, with additional computing effort of course being necessary for each iteration step.

One or more example embodiments of the present invention therefore integrates a movement compensation in the back projection and is particularly advantageous for a weighted and filtered back projection algorithm (WFBP algorithm) as is presented, for example, by K. Stierstorfer et al. (“Weighted FBP—a simple approximate 3D FBP algorithm for multislice spiral CT with good dose usage for arbitrary pitch”. Physics in Medicine & Biology, 49(11), 2209; 2004) and which can be advantageously used for CT reconstructions. The described movement compensation method is basically advantageous for each CT reconstruction method which uses rebinning and back projection steps, however.

In an embodiment, the inventive system for movement compensation during CT reconstruction is preferably configured for carrying out the inventive method. The system comprises the following components:
a data interface configured for receiving projection images of a CT scan,
a re-binning unit configured for creating intermediate images, wherein the intermediate images are created from a re-binning of the columns of the projection images,
a reconstruction unit configured for calculating slice images via a back projection of the intermediate images on predetermined voxels of the slice images.

The reconstruction unit comprises (in addition to the elements known for reconstruction in the prior art) the following additional components:
a movement module configured for selecting an initial movement state for an intermediate image or for ascertaining a changed movement state for a voxel on the basis of its calculated column image position in an intermediate image,
a positioning model configured for calculating a voxel position of the voxel from its original voxel position and the movement profile relating to a selected or calculated movement state,
a mapping module configured for calculating a column image position and a row image position at which a voxel would be mapped in an intermediate image,
an adoption module configured for adopting an image value of the intermediate image at the changed image position for use for the back projection.

The data interface is known in the prior art. It can be, for example, a network data interface and be configured, for example, to receive images via a PACS (Picture Archiving and Communication System). The data interface can also be a data bus of a CT system, however, via which acquired projection images of a CT scan are conducted.

The re-binning unit serves to create the intermediate images (stated in more detail above) via re-binning, for example images with parallel beam guidance.

A reconstruction unit is basically known in the prior art and serves to calculate the slice images. The reconstruction unit used here comprises the elements of a conventional reconstruction unit and additionally also the above-stated further modules, which will be described in more detail below.

The movement module is characterized in that it specifies a movement state. A movement state can be determined via two modes, for which reason the movement module can definitely have two sub-modules (but does not necessarily have to).

The first mode is selecting a movement state. This occurs on the basis of a specification by a user, a preset or by way of the currently used intermediate image. For example, the selection can be made such that a movement state is selected, which corresponds to a particular column position p of an intermediate image (for example its center). A movement state can also be selected, however, which is linked to a particular acquisition instant. The corresponding sub-module could be referred to as a “movement selection module”.

The second mode is ascertaining a movement state of a voxel on the basis of a calculated column image position p. This simply requires an indication of the column position, and a movement state is selected, which is linked to this column position (of the relevant intermediate image). The corresponding sub-module could be referred to as a “movement position module”.

Basically, a simple movement module can have an allocation table or allocation function via which a corresponding movement state can be allocated to an image coordinate of each intermediate image.

The positioning module has contact with the movement profile, for example via communication with a database or a memory area. There is information on movements of voxels available in the movement profile, for example in the form of functions or tables, and the positioning module is configured to retrieve this information and in particular to also write it in a predefined memory area.

A voxel position can be calculated as previously described. The positioning module can calculate both the reference voxel position and the changed voxel position since the principle of calculation is the same. It can also have two sub-modules for separate calculation of these variables, however.

The mapping module calculates the image positions as was stated above in more detail. In respect of the reference voxel position it is merely necessary to calculate the column image position of the voxel in the intermediate image, although its row image position can also be calculated as well. For the changed voxel position, both the column image position of the voxel in the intermediate image and its row image position have to be calculated, so the appropriate image information can be subsequently allocated to the voxel. The mapping module can definitely have two sub-modules for separate calculation of the variables.

The adoption module can easily achieve adoption of the image value of the intermediate image by copying the image information at previously calculated image coordinates and writing it into a dataset for the back projection.

The modules can be contained in a control facility (or device) of the CT system. An inventive control facility for controlling a computed tomography system is configured for carrying out an inventive method and/or comprises an inventive system.

An embodiment of the inventive computed tomography system (CT system) comprises an inventive control facility (or device) or an inventive system and is configured for carrying out an inventive method. CT systems per se are known in the prior art.

The majority of the previously mentioned components of the system or the control facility can be fully or partially implemented in the form of software modules in a processor of a corresponding computing system. An implementation largely in terms of software has the advantage that even previously used control facilities can be easily retrofitted by way of a software update in order to work inventively. In this regard, the object is also achieved by a corresponding computer program product having a computer program, which can be loaded directly in a computing system or a storage facility of a control facility of a computed tomography system, having program segments in order to execute all steps of the inventive method when the program is run in the computing system or the control facility. Apart from the computer program a computer program product of this kind can optionally comprise additional component parts, such as documentation and/or additional components, also hardware components, such as hardware keys (dongles, etc.) in order to use the software.

A computer-readable medium, for example a memory stick, a hard drive or another transportable or permanently installed data carrier on which the program segments of the computer programs, which can be read and executed by a computing system or a computer unit of the control facility, are stored, can serve for transportation to the computing system or the control facility and/or for storage on or in the computing system or the control facility. The computer unit can have for this purpose, for example, one or more cooperating microprocessor(s) or the like.

Further, particularly advantageous embodiments and developments of the present invention can be found in the dependent claims and the following description, it being possible for the claims of one category of claims to also be developed analogously to the claims and parts of the description relating to another category of claims and in particular also individual features of different exemplary embodiments or variants can be combined to form new exemplary embodiments or variants.

In a preferred method the initial movement state corresponds to a column image position p, which is located substantially in the center of the intermediate image. This means that the column image position P is located no further away than 5% of the total columns of the intermediate image from the center, preferably no further than 1% of the total columns.

A particularly preferred initial movement state corresponds to a column image position p, which corresponds to that column in the intermediate image, which in one of the projection images lay exactly in the center of the image.

Such an initial movement state is preferably selected for each intermediate image, therefore particularly preferably for each intermediate image an initial movement state corresponding to a column image position, which is located exactly in the center of the respective intermediate image.

According to a preferred method, in addition to a column image position, at which the voxel would be mapped in the intermediate image, a row image position calculated at which the voxel would be mapped in the intermediate image.

With regard to the movement profile and calculation of the voxel position, in practice it should be noted that there are often two main memories on the hardware side during the image reconstruction. A smaller, faster main memory and a larger, slower main memory. As a rule, the calculations are carried out in the fast main memory. It is accordingly advantageous to write, data, which is required for calculation, in the fast main memory, so the calculations are not slowed down unnecessarily due to access times to the slow main memory. Since, as stated above, the movement profile can be quite large, as a rule, it is present in the slow main memory (or a hard drive). For each intermediate image it could therefore be advantageous to load a certain number of movement data from the movement profile into the fast main memory and to interpolate movements, which lie between these movement states time-wise from the downloaded movement data. This can save computing time. Experiments have shown that in addition to the initial movement state, two further movement states are already sufficient for an effective movement compensation.

According to a preferred method, during back projection of the intermediate images, movement data (relating to voxel movements) is preselected from the movement profile for a number of the intermediate images, in particular for each intermediate image from the movement profile for the initial movement state and at least for one earlier and at least one later movement state. There is therefore, for example, movement data available for an initial movement state for a p-coordinate in the center of the intermediate image and movement data for a movement state for a p-coordinate to the left and to the right of the center respectively.

In this case, the changed voxel position x′ of the voxel is preferably calculated on the basis of this preselected movement data and the ascertained changed movement state in that “appropriate” movement data is interpolated for this changed movement state. Preferably the movement data of the closest movement states is used for this purpose.

The interpolation is therefore preferably based on those movement states, which are closest to the changed movement state. This means that the distance of the respective next preselected movement states from the column image position p of the reference voxel position xM is ascertained, and the (preselected) movement data of the movement profile of the adjacent movement states is used for calculating the changed voxel position x′. The distance of the image positions of the movement states is preferably incorporated in the form of a weighting. The closer the column image position p of the reference voxel position xM is to an adjacent movement state, the more its movement data is incorporated in the calculation of the voxel position.

In short: a few movement states (for example three) are selected, the movement data relating to these movement states is ascertained from the movement profile and, for a new movement state between the selected movement states, the relevant movement data is interpolated from that movement data of the adjacent movement states. The voxel position is then calculated using this interpolated movement data.

In the case of three movement states, with the initial movement state in the center (p0) and two movement states in the case of the two further P-coordinates pmin and pmax, it would therefore be ascertained in the case of a calculated column image position p, which P-coordinates are closest (for example pmin and p0), the distance of p to these coordinates ascertained (for example A1 at pmin and A2 at p0) and then a weighted calculation of the movement carried out with the weighting factors a1 and a2 (for example a1=A1/(A1+A2) and a2=A2/(A1+A2)). A preferred procedure for the “new” movement state T2 and the two adjacent known movement states T and T1 and the movement data RT, RT1, c(T), c(T1), z(T) and z(T1) for these two known movement states would be:
interpolating a rotation RT2 from RT and RT1.
interpolating a pivot point c(T2) from c(T) and c(T1), for example c(T2)=a1·c(T1)+a2·c(T).
interpolating a translation z(T2) from z(T) and z(T1), for example z(T2)=a1·z(T1)+a2·z(T).
calculating the changed voxel position using the formula: x1=RT2(x−c(T2))+c(T2)+z(T2)

It should be noted that in the case of a center, which does not match the center of the intermediate image, the outer regions Pmin (always negative) and Pmax (always positive) do not necessarily have to be symmetrically distributed about p=0 either and pmin≠−pmax can apply.

According to a preferred method, the following steps are run through at least once before using the image value for the back projection:
calculating a changed column image position p′ at which the voxel at the changed voxel position x′ would be mapped in the intermediate image,
ascertaining a changed movement state of the voxel on the basis of the changed column image position p′,
calculating a changed voxel position x′ of the voxel from its original voxel position x and the movement profile in relation to the changed movement state.

At least one new, changed voxel position respectively is therefore iteratively calculated. This takes account of the fact that each p-coordinate in an intermediate image simultaneously corresponds to an individual acquisition instant and therewith an individual movement state.

According to a preferred method, when creating the intermediate images a re-binning of the columns of the projection images takes place to the extent that for an intermediate image, those columns of the projection images are used, which were acquired with parallel X-ray beams respectively in a plane orthogonal to the columns. This is known in the prior art, but the inventive method is particularly well suited to such parallelized re-binning.

According to a preferred method, the intermediate images are filtered for a better reconstruction result, in particular via a convolution and/or a Fourier transform. In the case of a preferred convolution, a filtered intermediate image is calculated via a predefined kernel, in particular a ramp filter such as a Shepp-Logan kernel. In the case of the alternative filtering, the intermediate images are subjected to a Fourier transform and multiplied by an adjusted filter in the Fourier space. Both the filtering and the Fourier transform are basically known in the prior art.

According to a preferred method (a particular iterative method), after calculating the slice images from the intermediate images the following steps are carried out:

i) reconstruction of comparison intermediate images from the slice images on the basis of the movement profile,
ii) comparing the comparison intermediate images with the intermediate images,
iii) creating revised slice images on the basis of the comparison,
iv) iterative repetition of steps i) to iii) with the last-created slice images respectively.

According to a preferred method, during reconstruction of the comparison intermediate images the image points of the comparison intermediate images are ascertained for each image point of each comparison intermediate image according to the following steps:
calculating a beam through the image voxel starting from an image point of the comparison intermediate image,
ascertaining the movement data for a movement state according to the image position in the comparison intermediate image from the movement profile,
displacing the positions of beam and image voxels relative to each other according to the movement data of the movement profile relating to the movement state, in particular wherein the beam is moved according to the movement data,
accumulating values of the image voxels along the beam with the relative displacement of beam and image voxels,
adopting the accumulated values for the position in the comparison intermediate image.

A pixel at the position (p, q) in the intermediate image is therefore to be filled with a value. For this, a beam is calculated, which goes through the image voxels and is absorbed accordingly. The value of the (correct) beam should then be an accumulation of values of the image voxels along the beam. It is accordingly the case (corresponding to back projection) that at different times the voxel volume can have been situated at different locations. Since the column position p is known (it was selected), however, the associated movement state is also known and therewith also the associated movement data from the movement profile, which can either be derived or be interpolated directly from the movement profile. The interpolation functions as in the back projection. Using the corresponding movement data, start and end points of the beam can then be displaced in accordance with the movement (in particular in the case of a rigid movement) or alternatively (in particular in the case of a non-rigid movement), the image voxels can be displaced. For this moved beam (relative to the image voxels), the values along the beam are accumulated and this value is written to the original position (p,q). This is explicitly not the new position of the beam, but the pixel with which the process was begun, corresponding to the iteration by the pixels of the intermediate image.

Accordingly, in the case of a preferred system the reconstruction unit additionally comprises the following modules:
a beam simulation module configured for calculating a beam through the image voxel starting from an image point,
a movement simulation module configured for ascertaining the movement data of a movement state according to the column image position in the comparison intermediate image from the movement profile and for displacing the positions of beam and image voxels relative to each other according to the movement data of the movement profile relating to the movement state,
a simulation adoption module configured for accumulating values of the image voxels along the beam with relative displacement of beam and image voxels and for adopting the accumulated values for the position in the comparison intermediate image.

This iterative movement compensation method can be incorporated in the reconstruction process, and this results in a movement-compensated voxel volume. If, in order to obtain the comparison intermediate images, the forward projection step was carried out without taking into account the movement, the resulting comparison intermediate images would likewise be movement-compensated. They are compared with the original (non-compensated) intermediate images, however. During the forward projection step the same movement compensation calculations as in the back projection should thus be carried out, only in the “other direction”. In the forward projection the movement which was removed in the back projection step is added again (all on the basis of the movement profile). The movement is compensated again in the following back projection step.

Briefly summarized, during forward projection, (comparison) intermediate images are calculated from the slice images again, these (comparison) intermediate images are compared with the original intermediate images and the difference in the intermediate images is then back-projected again and the result offset with the previous slice images to achieve a more accurate result. The new, more accurate slice images are forward projected again and so on.

Preferably, components of the present invention are in the form of a “Cloud service”. A Cloud service of this kind is used for processing data, in particular via artificial intelligence, but can also be a service on the basis of conventional algorithms or a service in which an evaluation by humans takes place in the background. In general, a Cloud service (hereinafter also called “Cloud” for short) is an IT infrastructure in which, for example, storage space or computing power and/or application software is made available over a network. The user and the Cloud communicate via data interfaces and/or data transfer protocols. In the present case it is particularly preferred that the Cloud service makes both computing power and application software available.

Within the context of a preferred method data is provided to the Cloud service over the network. The Cloud service comprises a computing system, for example a computer cluster, which, as a rule, does not comprise the local computer of the user. This Cloud can be made available in particular by the medical facility, which also provides the medical-technical systems. By way of example, the data of an image acquisition is sent to a (remote) computer system (the Cloud) via an RIS (Radiology Information System) or PACS. Preferably, the computing system of the Cloud, the network and the medical-technical system represent a grouping in terms of data. The method can be implemented in the network via a command constellation. The data (“results data”) calculated in the Cloud is subsequently sent to the local computer of the user again over the network.

The disclosed invention significantly improves the results of movement compensation for known movements, in particular in combination with the WFBP algorithm, compared with the prior art. Following the movement-compensated reconstruction considerably fewer movement artifacts remain than, for example, with the method by Schafer et al., when it is combined with the WFBP algorithm. The main difference consists in that with the disclosed invention the re-binning process is taken into account in the movement compensation, and this results in a much more accurate representation of the movement state present in each step, whereby the remaining artifacts are ultimately reduced.

A considerable reduction in the movement artifacts improves the image quality and therewith the diagnostic value of the resulting images. An improvement in the image quality of movement-distorted CT scans is therefore very desirable for clinical practice since it enables greater accuracy in the diagnosis process.

In addition, the need to repeat CT scans owing to movement artifacts can be avoided by way of one or more example embodiments of the present invention. The repetition of CT acquisitions is accompanied by an increased dose for the patient, and this is very disadvantageous. Furthermore, re-scanning is time-consuming and could make use of urgently required resources.

In projects with mobile CT scanners the disclosed movement compensation method could result in an improvement in the image quality, and this makes the scanner more attractive for clinical practice.

### BRIEF DESCRIPTION OF THE DRAWINGS

The present invention will be illustrated once again in more detail below with reference to the accompanying figures and on the basis of exemplary embodiments. Identical components are provided with identical reference numerals in the various figures. As a rule, the figures are not to scale. In the drawings:

FIG. 1 shows a roughly schematic representation of a computed tomography system with an exemplary embodiment of a control facility with an inventive system for carrying out the method,

FIG. 2 shows a sequence plan for one possible sequence of an inventive method,

FIG. 3 shows a supplemented sequence plan for one possible sequence of an iterative method,

FIG. 4 shows a flowchart for a preferred iteratives method,

FIG. 5 shows a schematic representation of a preferred system,

FIG. 6 shows a mapping of moved voxels,

FIG. 7 shows a re-binning,

FIG. 8 shows a selection of a movement state,

FIG. 9 shows a result of the inventive method in comparison.

### DETAILED DESCRIPTION

In the following illustrations it is assumed that the imaging installation is a computed tomography system. Basically, the method can also be used in other imaging installations, however.

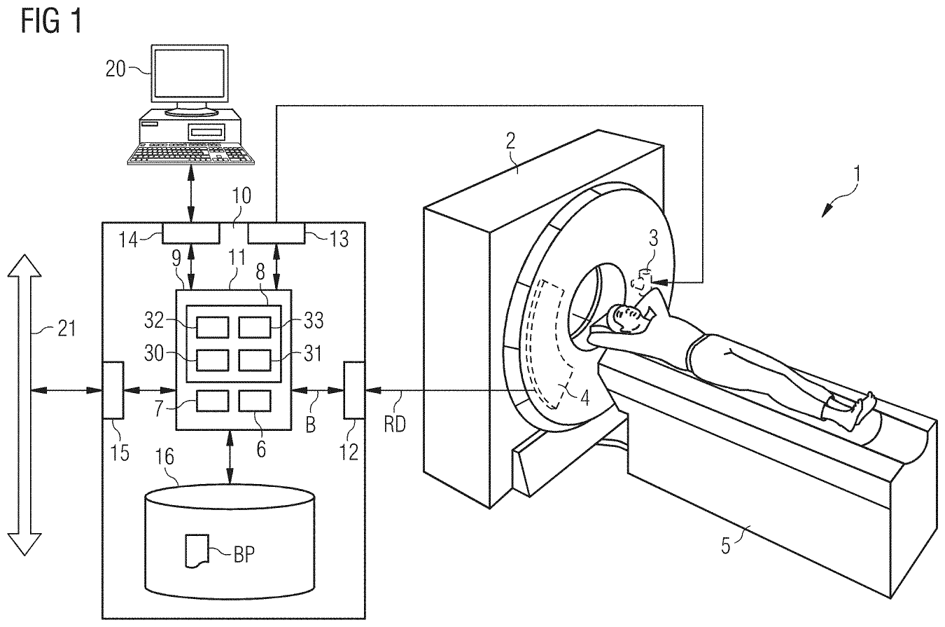

FIG. 1 shows a roughly schematic computed tomography system 1 having a control facility 10 for carrying out the inventive method. The computed tomography system 1 conventionally has a scanner 2 with a gantry in which an X-ray source 3 rotates which radiographs a patient respectively, which is pushed into a measuring space of the gantry via a couch 5, so the radiation impinges on a detector 4 opposing the X-ray source 3 respectively. Explicit reference is made to the fact that this exemplary embodiment is merely one example of a CT and the present invention can also be used on any CT constructions, for example having annular, fixed X-ray detector and/or a plurality of X-ray sources.

Similarly in the case of the control facility 10, only the components which are essential to the illustration of the present invention are represented. Basically, CT systems of this kind and associated control facilities are known to a person skilled in the art and therefore do not need to be illustrated in detail.

A core component of the control facility 10 here is a processor 11 on which different components in the form of software modules are implemented. The control facility 10 also has a terminal interface 14 to which a terminal 20 is connected, via which an operator can operate the control facility 10 and thus the computed tomography system 1. A further interface 15 is a network interface for connection to a data bus 21 in order to thus establish a connection to an RIS (Radiology Information System) or PACS (Picture Archiving and Communication System).

The scanner 2 can be actuated by the control facility 10 via a control interface 13, that is to say, for example the rotational speed of the gantry, the displacement of the patient couch 5 and the X-ray source 3 itself are controlled. The raw data RD is read from the detector 4 via an acquisition interface 12. Furthermore, the control facility 10 has a memory unit 16 in which, inter alia, different measuring protocols are stored.

As a software component an (image data) reconstruction unit 18 is implemented on the processor 11, with which unit the desired image data is reconstructed from the raw data RD obtained via the data acquisition interface 12. This reconstruction unit 18 modules of the system 9 for movement compensation during CT reconstruction. The system 9 itself comprises:

A data interface 6, which is configured here for receiving the raw data RD (or the projection images B of the data acquisition interface 12).

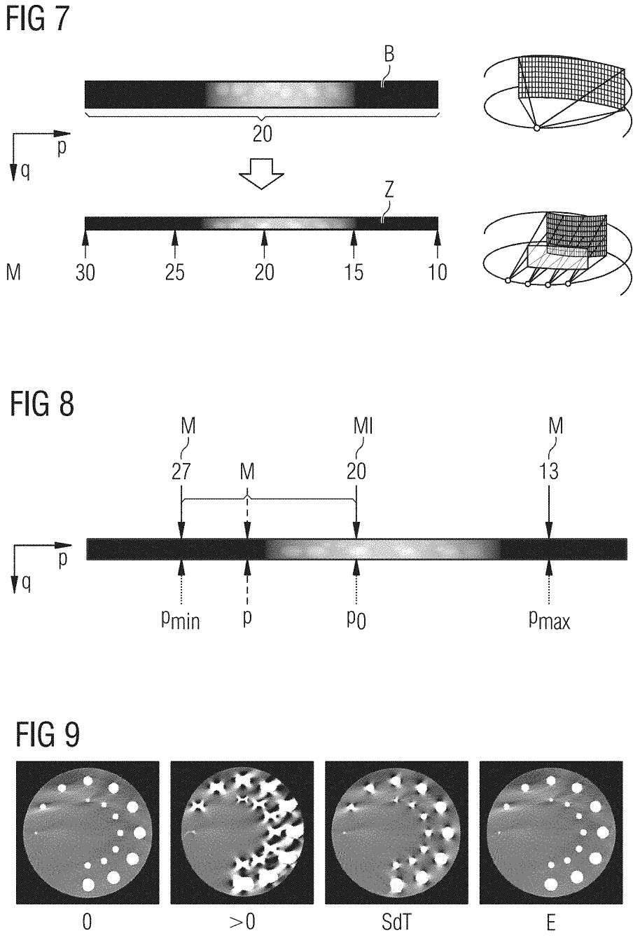

A re-binning unit 7 configured for creating intermediate images, it being possible for the intermediate images Z here to be created, for example as shown in FIG. 7, from a re-binning with parallel beam guidance.

The reconstruction unit 8 also comprises the following modules here:

A movement module 30 configured for selecting an initial movement state MI for an intermediate image Z or for ascertaining a changed movement state M for a voxel V on the basis of its calculated column image position p, p′ in an intermediate image Z. A movement state M, MI can therefore be determined via two modes. The first mode is selection of a movement state MI. This occurs here, for example, on the basis of a specification by the currently used intermediate image Z (see for example FIG. 8). By way of example, the selection can take place such that a movement state MI is selected, which corresponds to the center of the intermediate image Z. The second mode is ascertainment of a movement state M on the basis of a calculated column image position p. Simply an indication of the column position is required for this purpose, and a movement state M selected accordingly, which is linked to this column image position P (of the relevant intermediate image Z).

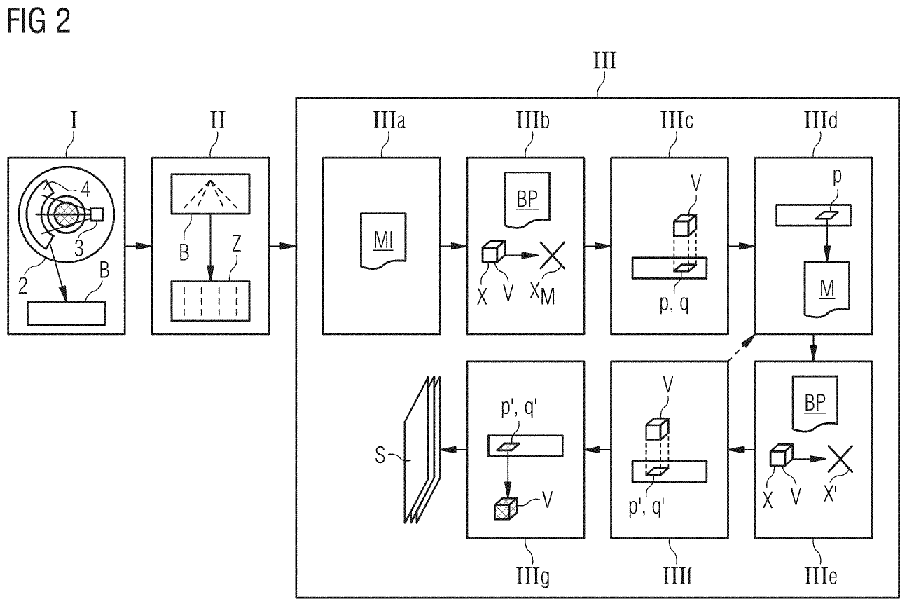

A positioning module 31 configured for calculating a voxel position x′, xM of the voxel V from its original voxel position x and the movement profile BP in relation to a selected or calculated movement state MI, M. The positioning module 31 has contact with a movement profile BP, which is present in the memory unit 16 here. Calculation of a voxel position will be described in more detail below in relation to FIG. 2, with the positioning module 31 here being capable of calculating both the reference voxel position xM and the changed voxel position x′.

A mapping module 32 configured for calculating a column image position p, p′ and a row image position q, q′ at which a voxel V would be mapped in an intermediate image Z. In respect of the reference voxel position xM it is merely necessary to calculate the column image position of the voxel V in the intermediate image Z, although its row image position q can also be calculated. For the changed voxel position x′, both the column image position p′ of the voxel in the intermediate image Z and its row image position q′ have to be calculated so subsequently the appropriate image information can be allocated to the voxel V.

An adoption module 33 configured for adopting an image value of the intermediate image Z at the changed image position p′, q′ for use for the back projection. The adoption module 33 can achieve adoption of the image value of the intermediate image Z for example simply by copying the image information at previously calculated image coordinates p′, q′ and writing it into a dataset for the back projection.

FIG. 2 shows a sequence plan for one possible sequence of an inventive method for movement compensation during the CT reconstruction.

In step I, projection images B of a CT scan are provided, with a beam from the X-ray source 3 of the CT scanner 2 in FIG. 1 being radiated onto the detector 4 here and a series of projection images B being acquired.

In step II, intermediate images Z are created, with the intermediate images Z being created from a re-binning of columns of the projection images B. Here parallelized intermediate images Z are created from projection images B, which were acquired with a conical beam.

In step III, slice images S are calculated via a back projection of the intermediate images Z onto predetermined voxels V of the slice images S, with the following steps being carried out for each intermediate image Z and for each voxel V on the basis of a predefined movement profile BP of the voxels V during acquisition of the projection images B:

In step IIIa, an initial movement state MI is selected on the basis of the intermediate image Z. This can correspond, for example, to a coordinate exactly in the center (for example in the center of the image) of the intermediate image Z.

In step IIIb, a reference voxel position xM of the voxel V is calculated from its original voxel position x and from the movement profile BP in relation to the initial movement state MI. The voxel V has potentially moved in the initial movement state MI to the reference voxel position xM in relation to the original voxel position x. This movement is taken into consideration here.

In step IIIc, a column image position p is calculated at which the voxel V would be mapped in the intermediate image Z at the reference voxel position xM. Here the complete image position p, q is calculated, with the row image position q not necessarily being required here. This can take place, for example, with a projection of the voxel V onto the intermediate image Z.

In step IIId, a changed movement state M of the voxel V is ascertained on the basis of the calculated column image position p.

In step IIIe, a changed voxel position x′ of the voxel V is calculated from its original voxel position x and the movement profile BP in relation the changed movement state M.

In step IIIf, a changed image position p′, q′ is calculated at which the voxel V would be mapped in the intermediate image Z at the changed voxel position x′.

In step IIIg, an image value of the intermediate image Z at the changed image position p′, q′ is used for the back projection.

A dashed-line arrow indicates that steps IIId to IIIf can be run through again or several times in the form of an iterative improvement of the result, with the changed column image position p′ then being used as the basis in step IIId.

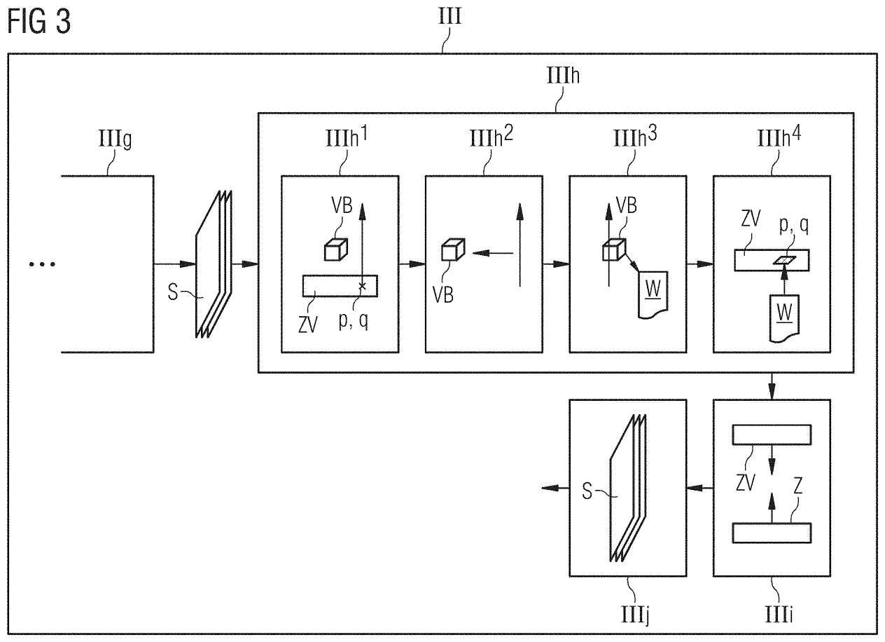

FIG. 3 shows a supplemented sequence plan for one possible sequence of an iterative method, wherein after calculating the slice images S from the intermediate images Z in FIG. 2, the following steps are carried out:

In step IIIh, comparison intermediate images ZV are reconstructed from the slice images on the basis of the movement profile BP. This step is divided here into four sub-steps.

In step IIIh1, a beam through the image voxels VB is calculated starting from an image point of the comparison intermediate image ZV.

In step IIIh2, the movement data is ascertained for a movement state M according to the column image position p in the comparison intermediate image ZV from the movement profile BP and displacement of the positions of beam and image voxels VB relative to each other according to the movement data of the movement profile BP relating to the movement state M, in particular with the beam being moved according to the movement data.

In step IIIh3, values of the image voxels VB are accumulated along the beam with the relative displacement of beam and image voxels VB.

In step IIIh4, the accumulated values are adopted for the position p, q in the comparison intermediate image ZV.

In step IIIi, the comparison intermediate images ZV are compared with the intermediate images Z.

In step IIIj, revised slice images S are created on the basis of the comparison.

The steps IIIh, IIIi and IIIj are iteratively repeated with the last-created slice images S respectively.

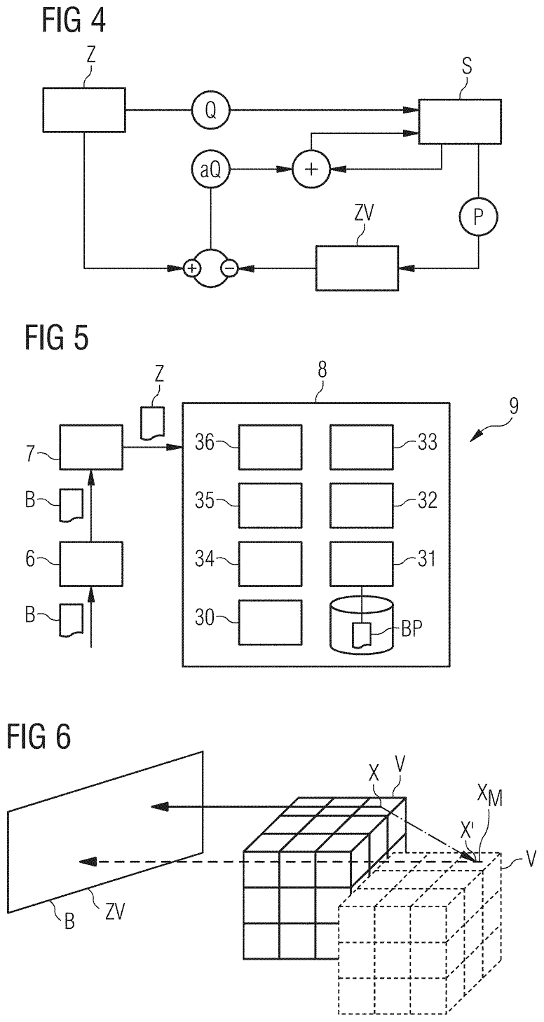

FIG. 4 shows a flowchart for a preferred iteratives method.

As described previously, slice images S are generated via a backward projection Q from the intermediate images Z (designated by Z0 in the following formula). This back projection Q combines the convolution and the back projection itself in one step. The first slice image S (f0 in the formula) is iteratively improved with each pass (fk). A forward projection (P in the formula) calculates a comparison intermediate image ZV (according to P(fk)) from a slice image S. The difference between the comparison intermediate image ZV and the original intermediate image Z is then calculated: P(fk)−Z0. The result is back projected again: Q(P(fk)−Z0) and the result deducted by a factor a from the previous slice image: fk−aQ(P(fk)−Z0). This produces the next slice image fk+1 and the steps are then repeated.

In the case of the forward projection, the movement is incorporated instead of removed as in the case of the back projection. Following the movement-compensated back projection the slice image S is ideally free from movement. In the case of the forward projection, iteration is no longer by way of the voxels for each comparison intermediate image ZV, but by way of the positions (p, q) of the comparison intermediate image ZV. For each position in the comparison intermediate image ZV, the associated beam through the corresponding voxel volume is calculated and the values of the voxel volume along the calculated beam are written to the position in the comparison intermediate image ZV.

Since the position in the comparison intermediate image ZV is known, the movement state M pertaining to the respective column image position p can be determined in order to incorporate the movement. By way of example, this movement state M can be used to move the beam through the voxel volume instead of the entire voxel volume itself. In principle, both are possible, however. The values along the newly calculated beam can now be written into the associated position in the comparison intermediate image ZV. A comparison intermediate image ZV is calculated thereby, which likewise includes the movement.

FIG. 5 shows a schematic representation of a preferred system 9. A basic construction of the system 9 has already been shown in FIG. 1, but this preferred embodiment, in addition to the data interface 6, re-binning unit 7 and the modules represented in FIG. 1: movement module 30, positioning module 31, mapping module 32 and adoption module 33, also has further modules in the reconstruction unit 8 with which the system 9 is configured for a method, as is shown in FIG. 3. These additional modules are:

A beam simulation module 34 configured for calculating a beam through the image voxels VB starting from an image point.

A movement simulation module 35 configured for ascertaining the movement data of a movement state M according to the column image position p in the comparison intermediate image ZV from the movement profile BP and for displacement of the positions of beam and image voxels VB relative to each other according to the movement data of the movement profile BP relating to the movement state M.

A simulation adoption module 36 configured for accumulating values of the image voxels VB along the beam with the relative displacement of beam and image voxels VB and for adopting the accumulated values for the position p, q in the comparison intermediate image.

FIG. 6 shows a mapping of moved voxels V. The cube in solid lines shows 27 voxels V, by which the voxel V is mapped on an image top right at the back in its original voxel position x. During the acquisition this was the projection image B and in an iterative method (see FIG. 3) was the comparison intermediate image ZV. As may be seen, on its path to the image a beam (arrow in solid lines) passes through a plurality of voxels, so the image value on the image does not necessarily have to match the image value of the voxel (and does not, as a rule, hence the complex back projection).

With reversed arrows the representation could also show an intermediate image Z.

During an acquisition the cube now moves along the arrow in dot-dash lines to a different position, which is indicated by a cube in dashed lines. Following the movement (depending on movement state MI, M) the voxel is situated at a reference voxel position xM or a changed voxel position x′ and is mapped on the image at a completely different position (dashed line arrow).

The movement shown here is a very simple one in which the voxels are thereafter all still in their original group. In reality this movement is, as a rule, more complicated and each voxel can move individually, although during a normal examination there is always a closed group in which adjacent voxels move in a very similar manner. By way of example, a beating heart moves but its wall (fortunately) always forms a closed body.

FIG. 7 shows re-binning of a projection image the B (top), which was acquired with a conical beam profile on a helical trajectory (see drawing on the right) in relation to an intermediate image Z (bottom). Owing to the calculations carried out during re-binning the movement state M of the intermediate image Z changes with the columns (direction p), but not with the rows (direction q). The center of the intermediate image Z includes the same movement state M here as the projection image B before re-binning. With a movement to the right in the image the previous movement states M exist; with a movement to the left in the image the subsequent movement states M exist. The exact position of each movement state M in the intermediate image Z has to be calculated individually since it depends on a plurality of parameters.

When the bottom right of the drawing is considered it is obvious that the intermediate image Z in this example does not have completely parallel but only semi-parallel geometry. Only when the beams in the p-direction are considered are the beams completely parallel. This is not the case along the q-direction. This does not pose a problem for One or more example embodiments of the present invention, however, since the q-coordinate is required merely for selection of the image values and can be easily determined.

FIG. 8 shows a selection of a movement state M and outlines ascertaining a movement of the voxel position x′.

The most accurate movement compensation method would be to use the exact movement for each movement state (therefore in each column image position p) of each intermediate image Z for the back projection step. This results in storage problems in the current implementation of the reconstruction algorithms, however. A compromise can be applied to this with which good results are obtained with less outlay on storage.

For this, during the back projection of the intermediate images Z, for a number of the intermediate images Z, in particular for each intermediate image Z, movement data is preselected from the movement profile BP for the initial movement state MI and at least for one earlier and at least one later movement state M. Here, apart from the initial movement state MI with the numeral 20, these are the movement states M 27 and 13.

For one (each) intermediate image Z, three movement states MI, M are therefore used here: one in the center, one on the left and one on the right. The movements in between are interpolated, for example using linear interpolation, from the previously selected movement data at the positions 13, 20 and 27. The fact that the left and right movement states M do not necessarily have to be located furthest left or right has to be taken into account, however, since, depending on parameters such as the field of view, these regions of the intermediate image Z are potentially not reached. The best position can be individually calculated by taking into account these parameters.

The movement state M (with p above the curly bracket) can therefore now be calculated and the changed voxel position x′ of the voxel V calculated on the basis of interpolated movement data on the basis of preselected movement data relating to the movement states 27 and 13. The proximity to adjacent movement states M can be incorporated in the form of a weighting.

FIG. 9 shows a result of the inventive method by comparison. The images show a simulated scan of a clock phantom reconstructed using the WFBP algorithm.

The left (0) shows an image of the unmoved object as a reference, which is to be mapped, or its reconstruction result, as it should ideally look after a reconstruction. To the right thereof (>0) is an image of a moved object (in the case of a translation) or its reconstruction result in the case of uncompensated movement. Severe artifacts can be seen, which have been caused by the movement. This mapping is to be improved by one or more example embodiments of the present invention relate.

A reconstruction according to the prior art (movement compensation method according to Schafer et. al.) is shown as a third image (SdT) when this is combined with the WFBP algorithm. While the artifacts could be significantly reduced there are still some artifacts present, which arise in places because the incorrect image information was allocated to the voxels during reconstruction.

The right-hand image (E) represents a reconstruction according to the inventive method, with the method merely having been applied once (and no additional iteration steps). Almost no movement artifacts can be seen. In this regard it should be stated that the right and left images appear identical at first glance, but on closer inspection (for example a subtraction) slight differences can be discerned. In the case represented here, the movement of the object was 100% known. More complicated movements could also cause slight artifacts in the inventive method, although these can be reduced with iterations of the method.

To conclude, reference is made once again to the fact that the methods described previously in detail and the represented computed tomography system 1 are merely exemplary embodiments, which can be modified in a wide variety of ways by a person skilled in the art without departing from the scope of the present invention. Furthermore, use of the indefinite article “a” or “an” does not preclude the relevant features from also being present several times. Similarly, the terms “unit” and “module” do not preclude the relevant components from being composed of a plurality of cooperating sub-components, which can optionally also be spatially distributed. The term “a number” should be taken to mean “at least one”.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Although the present invention has been shown and described with respect to certain example embodiments, equivalents and modifications will occur to others skilled in the art upon the reading and understanding of the specification. The present invention includes all such equivalents and modifications and is limited only by the scope of the appended claims.

What is claimed is:

1. A method for movement compensation during CT reconstruction, the method comprising:
providing projection images of a CT scan;
creating intermediate images from a re-binning of columns of the projection images; and
calculating slice images via back projection of the intermediate images onto voxels of the slice images; wherein
for each intermediate image and for each voxel, and based on a movement profile of the voxels during acquisition of the projection images, the method includes
selecting an initial movement state based on the intermediate image,
calculating a reference voxel position of the voxel from an original voxel position of the voxel and from the movement profile relative to the initial movement state,
calculating a column image position at which the voxel would be mapped in the intermediate image at the reference voxel position,
ascertaining a changed movement state of the voxel based on the column image position,
calculating a changed voxel position of the voxel from the original voxel position and the movement profile relative to the changed movement state,
calculating a changed image position at which the voxel would be mapped in the intermediate image at the changed voxel position, and
using an image value of the intermediate image at the changed image position for the back projection.

2. The method as claimed in claim 1, wherein the initial movement state corresponds to a column image position, which lies substantially at the center of the intermediate image.

3. The method as claimed in claim 2, wherein the center corresponds to a column at exactly the center of an image in one of the projection images.

4. The method as claimed in claim 1, wherein
during the back projection of the intermediate images, for a number of the intermediate images, movement data is selected from a movement profile for the initial movement state and at least for an earlier and at least one later movement state, and
the method includes
interpolating, from the selected movement data, the movement data relating to the changed movement state, and wherein
the calculating calculates the changed voxel position of the voxel based on the interpolated movement data relating to the changed movement state.

5. The method as claimed in claim 1, wherein for each intermediate image and for each voxel, the method comprises:
calculating a changed column image position at which the voxel would be mapped in the intermediate image at the changed voxel position; wherein
the ascertaining ascertains the changed movement state of the voxel based on the changed column image position.

6. The method as claimed in claim 1, wherein the creating the intermediate images comprises:
re-binning the columns of the projection images such that, for an intermediate image, columns of the projection images, which have been acquired with parallel X-ray beams respectively in a plane orthogonal to the columns, are used.

7. The method as claimed in claim 1, further comprising:
filtering the intermediate images via at least one of a convolution or a Fourier transform, and
in the case of filtering via the convolution, at least one of a filtered intermediate image is calculated via a kernel or an intermediate image is subjected to the Fourier transform and multiplied by an adjusted filter in the Fourier space.

8. The method as claimed in claim 1, wherein after calculating the slice images, the method comprises:
reconstructing comparison intermediate images from the slice images based on the movement profile;
comparing the comparison intermediate images with the intermediate images;
creating revised slice images based on the comparing; and
iteratively repeating the reconstructing, the comparing and the creating revised slices with last-created slice images.

9. The method as claimed in claim 8, wherein during reconstructing of the comparison intermediate images, for each image point of each comparison intermediate image, the image point of the comparison intermediate image is ascertained by
calculating a beam through image voxels starting from the image point of the comparison intermediate image,
ascertaining movement data for a movement state corresponding to a column image position in the comparison intermediate image from the movement profile,
displacing positions of the beam and the image voxels relative to each other according to the movement data of the movement profile relating to the movement state,
accumulating values of the image voxels along the beam with a relative displacement of the beam and the image voxels, and
adopting the accumulated values for the column image position in the comparison intermediate image.

10. A system for movement compensation during CT reconstruction, the system comprising:
a data interface configured to receive projection images of a CT scan;
a re-binning unit configured to create intermediate images from a re-binning of columns of the projection images;
a reconstruction unit configured to calculate slice images via back projection of the intermediate images onto voxels of the slice images, the reconstruction unit including
a movement module configured to select an initial movement state for an intermediate image or to ascertain a changed movement state for a voxel based on a column image position in the intermediate image,
a positioning module configured to calculate a voxel position of the voxel from an original voxel position and a movement profile relating to a selected or ascertained movement state,
a mapping module configured to calculate an image position at which the voxel would be mapped in the intermediate image, and
an adoption module configured to adopt an image value of the intermediate image at the image position for use for the back projection.

11. The system as claimed in claim 10, wherein the reconstruction unit comprises:
a beam simulation module configured to calculate a beam through image voxels starting from an image point;
a movement simulation module configured to ascertain movement data of a movement state according to a column image position in a comparison intermediate image from the movement profile and to displace positions of beam and image voxels relative to each other according to movement data of the movement profile relating to the movement state; and
a simulation adoption module configured to accumulate values of image voxels along the beam with a relative displacement of the beam and image voxels, and to adopt the accumulated values for the column image position in the comparison intermediate image.

12. A control device to control a computed tomography system comprising the system as claimed in claim 10.

13. A computed tomography system comprising the control device as claimed in claim 12.

14. A non-transitory computer program product, having a computer program, which is loadable into a storage device of a control device of a computed tomography system, the computer program having program segments that, when executed at the control device, cause the control device to perform the method as claimed in claim 1.

15. A non-transitory computer-readable medium including program segments that, when executed by at least one processor at a system, cause the system to perform the method as claimed in claim 1.

16. A system for movement compensation during CT reconstruction, the system comprising:
a data interface configured to receive projection images of a CT scan; and
at least one processor configured to execute computer-readable instructions to cause the system to
create intermediate images from a re-binning of columns of the projection images, and
calculate slice images via back projection of the intermediate images onto voxels of the slice images, wherein
for each intermediate image and each voxel, the at least one processor is further configured to execute the computer-readable instructions to cause the system to
select an initial movement state based on the intermediate image,
calculate a reference voxel position of the voxel from an original voxel position of the voxel and from a movement profile relative to the initial movement state,
calculate a column image position at which the voxel would be mapped in the intermediate image at the reference voxel position,
ascertain a changed movement state of the voxel based on the column image position,
calculate a changed voxel position of the voxel from the original voxel position and a movement profile relative to the changed movement state,
calculate a changed image position at which the voxel would be mapped in the intermediate image at the changed voxel position, and wherein
an image value of the intermediate image at the changed image position is used for the back projection.

17. The method of claim 2, wherein an initial movement state is selected for each intermediate image.

18. The method of claim 4, wherein the interpolating is based on movement states closest to the changed movement state, and a distance of image positions of the movement states is incorporated by weighting.

19. The method of claim 7, wherein the kernel is a Shepp-Logan kernel.

20. The method of claim 9, wherein the beam is moved according to the movement data.
